(19) United States
(12) Patent Application Publication
(10) Pub. No.: US 2014/0313287 A1
(43) Pub. Date: Oct. 23, 2014

(54) INFORMATION PROCESSING METHOD AND INFORMATION PROCESSING DEVICE

(71) Applicant: Linzhi Qi, Beijing (CN)

(72) Inventor: Linzhi Qi, Beijing (CN)

(21) Appl. No.: 13/983,594

(22) PCT Filed: Nov. 20, 2012
(86) PCT No.: PCT/CN2012/084911

§ 371 Date: Jul. 10, 2014

(51) Int. Cl. G06K 9/00; G06T 11/60; H04N 13/00

(52) U.S. Cl. CPC G06K 9/00791; H04N 13/0007; G06T 11/60
USPC 348/43

(57) ABSTRACT

An information processing method and information processing device helps drivers easily recognize the environment outside a vehicle. The method includes acquiring the current spatial position of a camera and its shooting range, constructing a three-dimensional scene of the shooting range and setting the display property of this three-dimensional scene as transparent, acquiring a two-dimensional view of this three-dimensional scene from the view point of the camera based on the three-dimensional scene and the distribution data of interest points within the shooting range, wherein the two-dimensional view includes the annotation of an interest point whose position in the two-dimensional view corresponds to the position of the interest point of the current frame captured by the camera, adjusting the size of the two-dimensional view to match it with the size of the frame captured by the camera, and outputting the frame superposed with the two-dimensional view.

### TECHNICAL FIELD

The present invention relates to an information processing method and an information processing device.

### BACKGROUND ART

As common electronic devices, navigators are equipped in more and more vehicles, providing drivers assistance for easy driving. A navigator can display the current position of the vehicle on a map as well as the basic information of interest points on the map. Interest points are pre-set points in the navigator's mapping software, which mainly include large buildings and pre-recorded names of relevant entities (such as companies, shops, etc.). The basic information of the interest points displayed on the map comprise mainly their titles, which help the drivers find their destinations.

When using a navigator, the driver usually, based on the relative position of the vehicle to the destination on the map displayed by the navigator, searches for his destination in the actual outdoor environment. Under such a situation, the driver usually relies on the visible buildings outside of his vehicle to determine a more accurate current position of his vehicle. As for the physical buildings outside of the vehicle, the driver can only recognize them by the external marks on their facades. However, during the actual driving, it is difficult for the driver to recognize from within the vehicle such external marks on the buildings or logos of the shops, especially when on unfamiliar streets, in which case it becomes more difficult for the driver to recognize the environment surrounding his vehicle. This is very inconvenient for the driver.

### SUMMARY OF THE INVENTION

Considering the above, the present invention provides an information processing method and an information processing device, which can help the driver easily recognize the environment outside his vehicle. Another object of the present invention is to help a user recognize his indoor or outdoor environment.

To achieve the above objects, according to one aspect of the present invention, an information processing method is provided.

The information processing method of the present invention includes: acquiring the current spatial position of a camera and its shooting range; constructing a three-dimensional scene of the shooting range and setting the display property of the three-dimensional scene as transparent; acquiring a two-dimensional view of the three-dimensional scene from the view point of the camera based on the three-dimensional scene and the distribution data of interest points within the shooting range, wherein the two-dimensional view includes annotation of an interest point whose position in the two-dimensional view corresponds to the position of the interest point in the current frame captured by the camera; adjusting the size of the two-dimensional view to match it with the size of the frame captured by the camera; and outputting the frame superposed with the two-dimensional view.

Optionally, the step of acquiring the current spatial position of a camera comprises comparing a currently captured frame and a stored indoor image after determining the camera to be indoor so as to determine the indoor position of the camera, or the step of acquiring the current spatial position of a camera comprises determining, after determining the camera to be indoor, the position of the camera when the current frame is being captured based on differences between the current frame captured indoor by the camera and the previous frame, and the indoor position of the camera when the previous frame was being captured.

Optionally, the camera is determined to be indoor based on a change in satellite positioning information.

Optionally, after outputting the frame superposed with the two-dimensional view, the method further includes searching in pre-stored information for the detailed information of the interest point corresponding to the annotation after receiving an access to the annotation in the frame superposed with the two-dimensional view, and outputting the detailed information of the interest point.

Optionally, the step of outputting the detailed information of the interest point includes replacing a text in the annotation of the interest point with the detailed information of the interest point, or replacing the annotation with an enlarged view or model.

Optionally, prior to adjusting the size of the two-dimensional view so as to match it with the size of the frame captured by the camera, the method further comprises, for a sheltered object from the view point of the camera in the three-dimensional model, setting the display property of the sheltered object as semi-transparent in the two-dimensional view.

Optionally, prior to adjusting the size of the two-dimensional view so as to match it with the size of the frame captured by the camera, the method further comprises receiving destination information, and marking up a navigation route in the two-dimensional view based on the destination information.

Optionally, the step of acquiring the two-dimensional view of the three-dimensional model from the view point of the camera based on the three-dimensional model and the distribution data of interest points within the shooting range comprises: acquiring the information of the interest point from the distribution data of interest points; obtaining the annotation of the interest point based on the information of the interest point; and adding the annotation of the interest point into the position in the three-dimensional scene corresponding to the interest point, and generating a two-dimensional view of the three-dimensional scene from the view point of the camera.

Optionally, the step of adding the annotation of the interest point into the position in the three-dimensional scene corresponding to the interest point comprises: determining a presentation style of the annotation of the interest point based on the positional relationship between the camera and the interest point; and adding the annotation of the interest point having the lighting presentation style into the position in the three-dimensional model corresponding to the interest point.

Optionally, the three-dimensional scene includes a sunshine simulation source; and the step of adding the annotation of the interest point into the position in the three-dimensional scene corresponding to the interest point comprises: determining a lighting presentation style of the annotation of the interest point based on a presentation position of the annotation of the interest point as well as a position of the sunshine simulation source, and adding the annotation of the interest point having the lighting presentation style into the position in the three-dimensional model corresponding to the interest point.

Optionally, the step of obtaining a two-dimensional view of the three-dimensional scene from the view point of the camera based on the three-dimensional scene and the distribution data of interest points within the shooting range comprises: acquiring the information of the interest point from the distribution data of interest points; obtaining the annotation of the interest point based on the information of the interest point; and generating a two-dimensional view of the three-dimensional scene from the view point of the camera and obtaining a position of the annotation of the interest point in the two-dimensional view, and adding the annotation of the interest point into the position in the two-dimensional view.

Optionally, the step of adding the annotation of the interest point into the position in the two-dimensional view comprises: determining a presentation style of the annotation of the interest point based on the positional relationship between the camera and the interest point; and adding the annotation of the interest point having the presentation style into the position of the annotation of the interest point in the two-dimensional view.

Optionally, the three-dimensional scene includes a sunshine simulation source; and the step of adding the annotation of the interest point into the position in the two-dimensional view comprises: determining a lighting presentation style of the annotation of the interest point based on a presentation position of the annotation of the interest point as well as a position of the sunshine simulation source; and adding the annotation of the interest point having the lighting presentation style into the position of the annotation of the interest point in the two-dimensional view.

According to another aspect of the present invention, an information processing device is provided.

The information processing device of the present invention comprises an acquisition module for acquiring the current spatial position of a camera and its shooting range; a three-dimensional modeling module for constructing a three-dimensional scene of the shooting range and setting the display property of the three-dimensional scene as transparent; an integration module for acquiring a two-dimensional view of the three-dimensional scene from the view point of the camera based on the three-dimensional scene and the distribution data of interest points within the shooting range, wherein the two-dimensional view includes the annotation of the interest point whose position in the two-dimensional view corresponds to the position of the interest point in the current frame captured by the camera; an adjustment module for adjusting the size of the two-dimensional view to match it with the size of the frame captured by the camera; and a superposition output module for outputting the frame superposed with the two-dimensional view.

Optionally, the acquisition module is further configured for comparing the currently captured frame and the stored indoor image after determining the camera to be indoor so as to determine the indoor position of the camera, or the acquisition module is further configured for determining, after determining the camera to be indoor, the position of the camera when the current frame is being captured based on differences between the current frame captured indoor by the camera and the previous frame, and the indoor position of the camera when the previous frame was being captured.

Optionally, the device further comprises an indoor determination module for determining the camera to be indoor based on a change in satellite positioning information.

Optionally, the device further comprises an access receiving module for receiving an access to the annotation in the frame superposed with the two-dimensional view; and an access response module for searching in pre-stored information for the detailed information of the interest point corresponding to the annotation, and outputting the detailed information of the interest point.

Optionally, the access response module is further configured for, for an interest point, replacing a text in the annotation of the interest point with the detailed information of the interest point, or replacing the annotation with an enlarged view or model.

Optionally, the device further comprises a sheltered object processing module for, prior to the adjustment by the adjustment module, for a sheltered object from the view point of the camera in the three-dimensional model, setting the display property of the sheltered object as semi-transparent in the two-dimensional view.

Optionally, the device further comprises a navigation routing module for, prior to the adjustment by the adjustment module, receiving destination information, and marking up a navigation route based the destination information in the two-dimensional view.

Optionally, the integration module is further configured for acquiring the information of the interest point from the distribution data of interest points, obtaining the annotation of the interest point based on the information of the interest point, adding the annotation of the interest point into the position in the three-dimensional model corresponding to the interest point, and generating the two-dimensional view of the three-dimensional model from the view point of the camera.

Optionally, the integration module is further configured for determining the presentation style of the annotation of the interest point based on the positional relationship between the camera and the interest point; and adding the annotation of the interest point having the presentation style into the position in the three-dimensional model corresponding to the interest point.

Optionally, the three-dimensional modeling module is further configured for setting up a sunshine simulation source in the three-dimensional scene; and the integration module is further configured for determining the lighting presentation style of the annotation of the interest point based on the presentation position of the annotation of the interest point as well as the position of the sunshine simulation source, and adding the annotation of the interest point having the lighting presentation style into the position in the three-dimensional model corresponding to the interest point.

Optionally, the integration module is further configured for acquiring the information of the interest point from the distribution data of interest points, obtaining the annotation of the interest point based on the information of the interest point, generating the two-dimensional view of the three-dimensional model from the view point of the camera, obtaining the annotation of the interest point in the two-dimensional view, and adding the annotation of the interest point into the position in the two-dimensional view.

Optionally, the integration module is further configured for determining the presentation style of the annotation of the interest point based on the positional relationship between the camera and the interest point, and adding the annotation of the interest point having the presentation style into the position in the three-dimensional model corresponding to the interest point.

Optionally, the three-dimensional modeling module is further configured for setting up a sunshine simulation source in the three-dimensional scene; and the integration module is further configured for determining the lighting presentation style of the annotation of the interest point based on the presentation position of the annotation of the interest point as well as the position of the sunshine simulation source, and adding the annotation of the interest point having the lighting presentation style into the position of the annotation of the interest point in the two-dimensional view.

Another aspect of the present invention relates to a computer program product for use in combination with a computer system, which comprises a computer readable storage medium and a computer program embedded therein, the computer program comprising: instructions for acquiring the current spatial position of a camera and its shooting range; instructions for constructing a three-dimensional scene of the shooting range, and setting the display property of the three-dimensional scene as transparent; instructions for obtaining a two-dimensional view of the three-dimensional scene from the view point of the camera based on the distribution data of interest points within the shooting range, wherein the two-dimensional view includes the annotation of the interest point whose position in the two-dimensional view corresponds to the position of the interest point of the current frame captured by the camera; instructions for adjusting the size of the two-dimensional view to match it with the size of the frame captured by the camera; and instructions for outputting the frame superposed with the two-dimensional view.

According to the technical solution of the present invention, a three-dimensional scene is constructed for the shooting range, annotation are added to interest points based on the three-dimensional scene, and the two-dimensional view having the annotation and corresponding to the three-dimensional scene is superposed with the frame captured within the shooting range, such that the user can obtain the information of the interest point in the video content when watching the video composed of continuous frames. This helps the user recognize the environment he is in. The technical solution of the present embodiment can be used not only indoor but also outdoor.

### BRIEF DESCRIPTION OF THE DRAWINGS/FIGURES

The figures are used to better illustrate the present invention, and do not set improper restrictions on the present invention, wherein:

FIG. 1 is a schematic diagram of the main composite parts of the information processing device relevant to an embodiment of the present invention;

FIG. 2 is a schematic diagram of the basic steps of the information processing method according to an embodiment of the present invention;

FIG. 3 is a schematic diagram of different presentation styles of a annotation under the various positional relationships between the camera and the interest point according to an embodiment of the present invention;

FIG. 4 is a schematic diagram of the basic structure of the information processing device according to an embodiment of the present invention.

### DETAILED DESCRIPTION OF THE EMBODIMENTS

The following part will illustrate the exemplary embodiments of the present invention with reference to the figures, including various details of the embodiments of the present invention for better understanding. The following embodiments should be regarded only as illustrative. Therefore, those skilled in the art should recognize that various changes and modifications to the embodiments illustrated below will not deviate from the scope and spirit of the present invention. Similarly, for clarity reasons, known functions and structures are omitted in the following depictions.

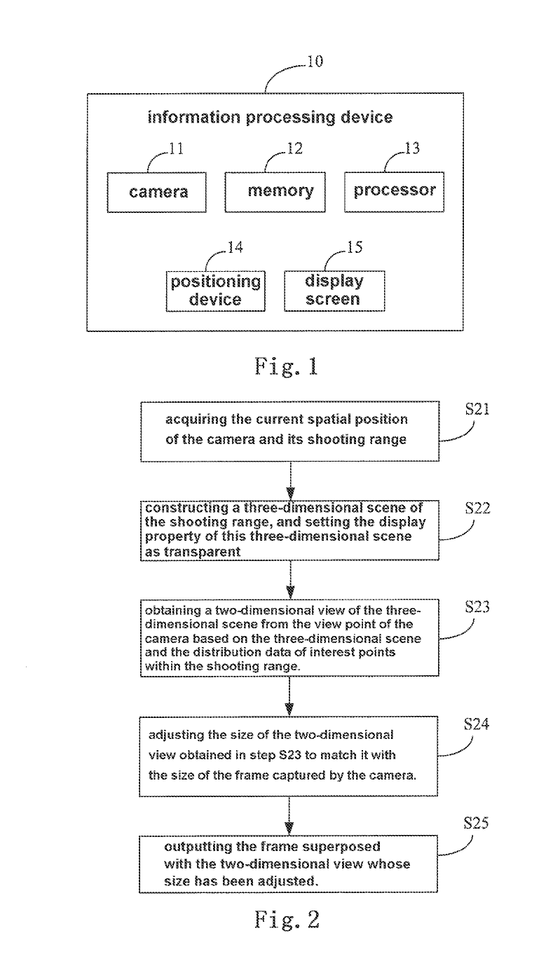

In an embodiment of the present invention, the information processing device comprises a camera device and a processor, as well as other necessary devices such as memory, positioning device, display screen, etc. As shown in FIG. 1, FIG. 1 is a schematic diagram of the main composite parts of the information processing device relevant to an embodiment of the present invention. As shown in FIG. 1, in an information processing device 10, a camera 11 captures an image of the current environment, e.g., a picture of the environment outside of the vehicle; a memory 12 stores a mapping application and other databases; a processor 13 can run the mapping application and perform other calculations and operations, and receive the positional information sent by a positioning device 14 (mainly latitude and longitude coordinate values obtained based on satellite positioning signals); and a display screen 15 is used for outputting information. The above information processing device can be an intelligent mobile phone having a camera and positioning functionalities (e.g., the capability of measuring the latitude and longitude, and altitude, using the Global Positioning System (GPS)) or a system composed of separate devices.

One technical effect to be achieved by the present invention is: while the image captured by the camera 11 is displayed on the display screen 15, what is displayed near the building as an interest point also includes information about the interest point. For example, in the image, as the Great Wall Hotel appears on the right side of the road, the four Chinese characters “ [symbol] ” (the Great Wall Hotel) or the two Chinese characters “ [symbol] ” (Hotel) are also displayed near the Great Wall Hotel in the image on the display screen 15. The technical solution of the present embodiment will be further illustrated bleow.

FIG. 2 is a schematic diagram of the basic steps for the information processing method according to an embodiment of the present invention. As shown in FIG. 2, the information processing method of the embodiment of the present invention basically includes steps S21 to S25.

S21: acquiring the current spatial position of the camera and its shooting range, wherein the current spatial position of the camera can be the latitude and longitude coordinate values provided by a positioning device, and the shooting range includes the right and left boundaries of the camera view finding frame and a field depth within a certain range.

S22: constructing a three-dimensional scene of the shooting range, and setting the display property of this three-dimensional scene as transparent. The shooting range mainly includes buildings, trees, etc. In this step, based on the frames acquired by the camera, three-dimensional models of objects in the frame are constructed, which have positional relationships in the three-dimensional space relative to each other, and the sets of these three-dimensional models having positional relationships to each other constitute a three-dimensional scene. Since it is not necessary to acquire the detailed information of the relatively far buildings at the time, the field depth within a certain range as noted above actually refers to the range within which the three-dimensional model is to be constructed. That is, three-dimensional models are constructed only for the objects within this range.

The accuracy of the three-dimensional models in this step only requires that the volume ratio and the positional relationship be satisfied, and the detailed parts of each of the objects can be skipped. Users can download, for example from the Internet, the profile data of the building along the current street block the camera is located in, as the reference for constructing the three-dimensional models.

S23: obtaining a two-dimensional view of the three-dimensional scene from the view point of the camera based on the three-dimensional scene and the distribution data of the interest points within the shooting range. In the two-dimensional view in this step, it is required that the annotation of the interest points are present, and their positions in the two-dimensional view correspond to the respective positions of the interest points in the current frame captured by the camera.

The above distribution dada of the interest points can be from the mapping software. The mapping software also includes information about the interest points, such as the titles of the buildings, addresses, telephone numbers, and brief introductions, etc. Since the annotation of the interest points will be marked near the buildings on the display screen, brief information is preferred for easy display on the display screen. Users can make a selection from information about interest points, e.g., they may select the building title of an interest point as its annotation.

The two-dimensional view in step S23 can be obtained in the following two manners: the first one is to first add the annotation of an interest point into a position in the three-dimensional mode corresponding to the interest point, and then generate a two-dimensional view of the three-dimensional model from the view point of the camera. During the processing in this manner, the annotation of the interest point becomes part of the three-dimensional model, and thus it participates in the calculation and processing of the three-dimensional model such as rendering, which will consume more resources of the processor.

The other one is that, after generating the two-dimensional view of the three-dimensional model from the view point of the camera and obtaining the position of the annotation of the interest point in the two-dimensional view, the annotation of the interest point is added into this position in the two-dimensional view. Since the annotation of the interest point is not involved in the processing in the three-dimensional model, it is fast to obtain the two-dimensional view having the annotation.

S24: adjusting the size of the two-dimensional view acquired in step S23 to match it with the size of the frame captured by the camera.

S25: outputting the frame superposed with the two-dimensional view whose size has been adjusted. As it can be seen, by superposing the two-dimensional view having the annotation of the interest point onto the frame captured by the camera, the frame will have the annotation of the interest point, and this annotation will be displayed near the interest point. If such devices as camera and display device are implemented inside the vehicle, it will be helpful for the driver to recognize the surrounding environment, and therefore it will be convenient for driving.

In the above solution, the annotation of the interest point outputted on the display screen is generally brief. If the user desires to know further information about the interest point, he can access the annotation. In the case where the display screen is a touch screen, a user operation on the touch screen such as tapping on the annotation can be received. Under this situation, the processor can search for the detailed information of the interest point corresponding to the annotation in the pre-stored information in the memory, and then output the detailed information. Such detailed information can be various types of files, including text, image, video, etc.

The output annotation is usually of text format, whose presentation styles include fonts, colors, three-dimensional effects, view size, etc., and can be flexibly selected. The detailed information are usually textual, too. As to the output format of the detailed information, the texts in the displayed annotation can be replaced with the detailed information of the interest point. The original presentation style can be retained, or other styles can also be used, e.g., an enlarged view or model can replace the original annotation.

As to the style of the output annotation, one preferred embodiment is to determine the presentation style of the annotation of the interest point based on the positional relationship between the camera and the interest point; and if the processing proceeds in the first manner as noted in Step S23, the annotation of the interest point having the above presentation style is added into the position in the three-dimensional model corresponding to the interest point; and if the processing proceeds in the second manner as noted in Step S23, the annotation of the interest point having this presentation style is added into the position of the annotation of the interest point in the two-dimensional view.

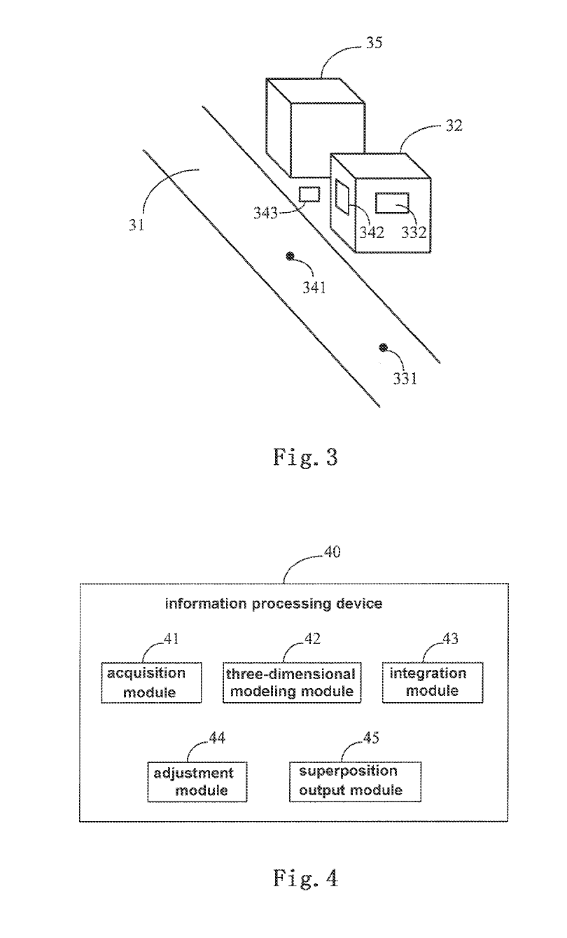

With reference to FIG. 3, the following part will illustrate by examples how the presentation style of the annotation of the interest point is determined based on the positional relationship between the camera and the interest point. FIG. 3 is a schematic diagram of the different presentation styles of a annotation under different positional relationships between the camera and the interest point according to an embodiment of the present invention.

As shown in FIG. 3, the vehicle is moving on the road 31, and on the right side of the road 31 is the building 32 as an interest point. While the vehicle is at position 331, the annotation 332 of the building 32 can be displayed on the right front side in upright characters, the effect of which on the display screen is that the characters are close to the middle and lined from left to right. When the vehicle is at position 341, the annotation 342 of the building 32 can be displayed on the right side and in italic, the effect of which on the display screen is that the characters are close to the right and lined from the upper left side to the lower right side. If the presentation style of the annotation 332 is still preserved, that is, it is displayed as the annotation 343, it would be easy to be confused with the annotation of the front building 35, since, in this case, the annotation of the building 35 will be presented as the annotation 343, using the same presentation style as that for the annotation 332.

Since almost every object in the frame captured by the camera outdoor will have a shade caused by sunlight (In cases where there is no direct sunshine, such as on cloudy days, it will be the natural light). In order to ensure that the annotation possesses more optimized presentation effects, the annotation can be made so that it possesses the same shade. For this purpose, a sunshine simulation source can be set up in the three-dimensional scene, i.e., a light source in the three-dimensional scene is set up based on the sunlight shining direction or natural lighting in the current spatial volume surrounding the camera.

If the first manner in Step S23 is adopted to add the annotation of the interest point, the lighting presentation style of the annotation of the interest point can be determined first based on the presentation position of the annotation of the interest point and the position of the sunshine simulation source, and then the annotation of the interest point is added into the position in the three-dimensional model corresponding to the interest point as having the lighting presentation style. If the second manner in Step S23 is adopted to add the annotation of the interest point, the lighting presentation style of the annotation of the interest point can be determined first based on the presentation position of the annotation of the interest point and the position of the sunshine simulation source, and then the annotation of the interest point is added into the position of the annotation of the interest point in the two-dimensional view as having the lighting presentation style.

In Step S22, the purpose of setting the display property of the three-dimensional scene as transparent is not to affect the image display in the frame after the superposing operation in Step S25. Of course, the display property of the annotation as noted above must be visible. Since the buildings visible to the driver during his driving are usually sheltered in parts from each other, the sheltered parts can be expressed in certain forms for the user's reference. For this purpose, in the three-dimensional scene, the display property of the sheltered objects from the view point of the camera will be set as semi-transparent. Such sheltered objects can be part of a certain object such as part of a building, or the entire object. As to the buildings, their profiles can be obtained from the street view data on the Internet. As to other objects, the sheltered objects can be derived from the visible parts. For example, if a certain section of a slope is sheltered, then the slope gradient of this section can adopt the slope gradient of the unsheltered parts.

As to the two-dimensional view in Step S23, a navigation route can be added thereto. A destination information may be received from a user as an input; and the processor plans the route according to the mapping application to obtain a navigation route, and marks it up in this two-dimensional view. In this way, the final output frame will include the navigation route, which can help the driver drive his vehicle according to the marked route intuitively.

The above depictions mainly involve an implementation scenario wherein the devices, such as the camera, are located outdoor, particularly inside moving vehicles. The technical solution of the present embodiment can also be applied indoor. As to some buildings having complex interior structures, the following solution can be used to help the user recognize his location.

When the user, equipped with the above information processing device, enters a certain building, the foremost task is to confirm that he is inside the building, so as to decide not to use the outdoor map any more. It may then help the user recognize the current environment with reference to the information such as the house floor plan and images taken from various indoor positions, as illustrated below. Since there is a big difference in strength between the indoor and outdoor satellite signals, when the user's positioning device is indoor, the information processing device can determine to be indoor based on the low strength (e.g., lower than certain pre-set empirical threshold) of the satellite signals received by the positioning device.

Images of various indoor positions can be captured and stored in advance by adopting a similar method of a existing mapping application having street views. The shooting points of these images can be recorded in the house floor plan, to make the house floor plan similar to maps in navigation systems. As to multi-floor buildings, house floor plan should be the floor plan of each floor. By measuring the altitude, the floor the user is on can be determined. In this way, after the user, equipped with such a camera, enters the building, the frames captured by the user on the spot and the stored indoor images can be compared using an image comparing technology, and the indoor image most similar to the currently captured frame can be selected. The shooting point of this indoor image can be regarded as the indoor position of the camera, or the coordinates of the shooting point of the indoor image is appropriately changed to become the current coordinates of the camera based on the differences obtained by comparing the currently captured frame with the indoor image most similar to this frame. The origin of this coordinate system can be selected freely, such as the southwestern point of the building, or a certain entrance.

When the position of the user is very close to the shooting point of a certain stored image, the stored indoor image can be used to adjust the position of the user, and prompt information can be output to help the user adjust his position towards the shooting point of the certain stored indoor image. Further, the position can be determined based on the differences between previously and currently captured frames. Specifically, based on the differences between the current frame captured indoor by the camera and the previously captured frame, as well as the camera's indoor position when this previous frame was captured, the camera's position when shooting the current frame can be determined.

Various interest points can be set in the above house floor plan, and the information of each interest point can be stored. Such interest points include the entrance and exit of each room, furniture or decoration possessing prominent visual effects, etc. In this way, interest points can be marked on the frame according to the steps shown in FIG. 2. Marking of such interest points is helpful for the user to recognize his surrounding environment. If the user further refers to the house floor plan at this time, and finds in the floor plan the interest points marked on the current frame, the user will know clearly his current position.

FIG. 4 is a schematic diagram of the basic structure of the information processing device according to an embodiment of the present invention. This information processing device can be provided in the information processing equipment mentioned above. As shown in FIG. 4, an information processing device 40 mainly comprises an acquisition module 41, a three-dimensional modeling module 42, an integration module 43, an adjustment module 44, and a superposition output module 45.

The acquisition module 41 is configured for acquiring the current spatial position of the camera and its shooting range; the three-dimensional modeling module 42 is configured for constructing a three-dimensional scene of the shooting range, and setting the display property of the three-dimensional scene as transparent; the integration module 43 is configured for obtaining the two-dimensional view of the three-dimensional scene from the view point of the camera based on the three-dimensional scene and the distribution data of interest points within the shooting range, wherein the two-dimensional view includes annotation of an interest point, the position of this annotation in the two-dimensional view corresponds to the position of the interest point in the current frame captured by the camera; the adjustment module 44 is configured for adjusting the size of the two-dimensional view to match it with the size of the frame captured by the camera; and the superposition output module 45 is configured for outputting the frame superposed with the two-dimensional view.

The acquisition module 41 can be further configured for, after determining that the camera is indoor, comparing the currently captured frame and the stored indoor images so as to determine the indoor position of the camera, or can further be configured for, after determining the camera is indoor, determining the camera's position while shooting the current frame based on the differences between the current frame captured indoor by the camera and the previous frame, and the indoor position of the camera while shooting this previous frame.

The information processing device 40 may further include an indoor determination module (not shown in the figures) for determining whether the camera is indoor based on the changes in satellite positioning information.

The information processing device 40 may further include an access receiving module and an access response module (not shown in the figures), wherein the access receiving module is configured for receiving an access to the annotation in the frame superposed with the two-dimensional view, and the access response module is configured for searching in pre-stored information for the detailed information of the interest point corresponding to the annotation, and outputting the detailed information of the interest point. The access response module can further be configured for, for an interest point, replacing a text in the annotation of the interest point with the detailed information of the interest point, or replacing the annotation with an enlarged view or model.

The information processing device 40 may further include a sheltered object processing module (not shown in the figures), which is used, prior to the adjustment action by the adjustment module 44, to set in the two-dimensional view the display property of the sheltered objects from the view point of the camera in the three-dimensional model as semi-transparent. The information processing device 40 may further include a navigation marking module (not shown in the figures) for, prior to the adjustment action by the adjustment module 44, receiving destination information, and marking up the navigation route in the two-dimensional view based on the destination information.

The integration module 43 can also be configured for acquiring information of an interest point from the distribution data of interest points, obtaining the annotation of the interest point based on the information of the interest point, adding the annotation of the interest point into the position in the three-dimensional model corresponding to the interest point, and generating a two-dimensional view of the three-dimensional scene from the view point of the camera. The integration module 43 can further be configured for determining the presentation style of the annotation of the interest point based on the positional relationship between the camera and the interest point, and adding into the position in the three-dimensional model corresponding to the interest point the annotation of the interest point having the presentation style.

The three-dimensional modeling module 42 can also be configured for setting up a sunshine simulation source in the three-dimensional scene. Accordingly, the integration module 43 can also be configured for determining the lighting presentation style of the annotation of the interest point based on the presentation position of the annotation of the interest point and the position of the sunshine simulation source, and adding into the position in the three-dimensional model corresponding to the interest point the annotation of the interest point having the lighting presentation style.

The integration module 43 can also be configured for acquiring the information of the interest point from the distribution data of interest points; acquiring the annotation of an interest point based on the information of the interest points; generating a two-dimensional view of the three-dimensional model from the view point of the camera, obtaining the position of the annotation of the interest point in the two-dimensional view, and adding the annotation of the interest point into the two-dimensional view accordingly. The integration module 43 can also be configured for determining the presentation style of the annotation of the interest point based on the positional relationship between the camera and the interest point; adding the annotation of the interest point having the presentation style into the position of the annotation of the interest point in the two-dimensional view.

According to a technical solution of an embodiment of the present invention, a three-dimensional scene is constructed for the shooting range, annotation is added to an interest point based on the three-dimensional scene, and a two-dimensional view having the annotation and corresponding to the three-dimensional scene is superposed onto the frame captured within the shooting range, such that the user can obtain information of the interest points in the video content when watching the video composed of such continuous frames. This helps the user recognize the environment he is in. The technical solution of the present embodiment can be used not only in the indoor situation but also in the outdoor situation.

The above describes the present invention's basic principles with reference to the specific embodiments. However, it is necessary to point out that those skilled in the art should understand that all or any step or part of the method and device of the present invention can be implemented in the forms of hardware, firmware, software or a combination thereof, in any computing device (including a processor, a storage medium, etc.) or network of computing devices. This can be realized by those skilled in the art by applying their basic programming skills after they have read the description of the present invention.

Therefore, the purpose of the present invention can also be realized by running a program or a set of programs on any computing devices. The computing devices can be known general devices. Therefore, the purpose of the present invention can also be realized only by providing a program product including program codes implementing the above described method or device. That is, such a program also constitutes the present invention, and such a storage medium storing such a program product also constitutes the present invention. Obviously, such a storage medium can be any known storage medium or any storage medium developed in the future.

It also needs to be pointed out that in the device and method of the present invention, obviously, each part or each step can be disassembled and/or re-assembled. These disassembling and/or re-assembling should be regarded as equivalent solutions of the present invention. Furthermore, the above processing steps can be carried out naturally based on the time sequence, but it is not necessary that the time sequence be strictly followed in execution. Some steps can be carried out in parallel or independently.

The above specific embodiments do not set any restrictions on the protection scope of the present invention. Those skilled in the art should understand that based on design requirements and other factors, various modifications, combinations, sub-combinations and substitutes can be made. Any modification, equivalent substitute, improvement, etc. within the principle of the present invention shall be regarded as within the protection scope of the present invention.

### DRAWINGS OF THE DESCRIPTION

FIG. 1
10 information processing device;
11 camera;
12 memory;
13 processor;
14 positioning device;
15 display screen

FIG. 2

S21:acquiring the current spatial position of the camera and its shooting range.
S22: constructing a three-dimensional scene of the shooting range, and setting the display property of this three-dimensional scene as transparent.
S23: obtaining a two-dimensional view of the three-dimensional scene from the view point of the camera based on the three-dimensional scene and the distribution data of interest points within the shooting range.
S24: adjusting the size of the two-dimensional view obtained in step S23 to match it with the size of the frame captured by the camera.
S25: outputting the frame superposed with the two-dimensional view whose size has been adjusted.

FIG. 3

FIG. 4
40 information processing device;
41 acquisition module;
42 three-dimensional modeling module;
43 integration module;
44 adjustment module;
45 superposition output module

1. An information processing method, comprising:
acquiring the current spatial position of a camera and its shooting range;
constructing a three-dimensional scene of the shooting range and setting the display property of the three-dimensional scene as transparent;
acquiring a two-dimensional view of the three-dimensional scene from the view point of the camera based on the three-dimensional scene and the distribution data of interest points within the shooting range, wherein the two-dimensional view includes the annotation of an interest point whose position in the two-dimensional view corresponds to the position of the interest point in the current frame captured by the camera;
adjusting the size of the two-dimensional view to match it with the size of the frame captured by the camera; and
outputting the frame superposed with the two-dimensional view.

2. The information processing method according to claim 1, wherein acquiring the current spatial position of a camera comprises comparing a currently captured frame and a stored indoor image after determining the camera to be indoor so as to determine the indoor position of the camera, or acquiring the current spatial position of a camera comprises determining, after determining the camera to be indoor, the position of the camera when the current frame is being captured based on differences between the current frame captured indoor by the camera and the previous frame, and the indoor position of the camera when the previous frame was being captured.

3. The information processing method according to claim 2, determining the camera to be indoor based on a change in satellite positioning information.

4. The information processing method according to claim 1, further comprising, after the step of outputting the frame superposed with the two-dimensional view:
searching in pre-stored information for the detailed information of the interest point corresponding to the annotation after receiving an access to the annotation in the frame superposed with the two-dimensional view, and outputting the detailed information of the interest point.

5. The information processing information according to claim 4, wherein the step of outputting the detailed information of the interest point comprises:
replacing a text in the annotation with the detailed information of the interest point, or replacing the annotation with an enlarged view or model.

6. The information processing method according to claim 1, further comprising, prior to adjusting the size of the two-dimensional view to match it with the size of the frame captured by the camera: for a sheltered object from the view point of the camera in the three-dimensional model, setting the display property of the sheltered object as semi-transparent in the two-dimensional view.

7. The information processing method according to claim 1, further comprising, prior to adjusting the size of the two-dimensional view to match it with the size of the frame captured by the camera: receiving destination information, and marking up a navigation route in the two-dimensional view based on the destination information.

8. The information processing method according to claim 1, wherein the step of acquiring the two-dimensional view of the three-dimensional model from the view point of the camera based on the three-dimensional model and the distribution data of interest points within the shooting range comprises:
acquiring information of the interest point from the distribution data of interest points;
acquiring the annotation of the interest point based on the information of the interest point; and
adding the annotation of the interest point into the position corresponding to the interest point in the three-dimensional scene, and generating a two-dimensional view of the three-dimensional scene from the view point of the camera.

9. The information processing method according to claim 8, wherein the step of adding the annotation of the interest point into the position corresponding to the interest point in the three-dimensional scene comprises:
determining the presentation style of the annotation of the interest point based on the positional relationship between the camera and the interest point; and
adding the annotation of the interest point having the presentation style into a position in the three-dimensional model corresponding to the interest point.

10. The information processing method according to claim 8, wherein:
the three-dimensional scene includes a sunshine simulation source;
the step of adding the annotation of the interest point into the position in the three-dimensional scene corresponding to the interest point comprises:
determining a lighting presentation style of the annotation of the interest point based on a presentation position of the annotation of the interest point as well as a simulated sunlight;
adding the annotation of the interest point having the lighting presentation style into the position in the three-dimensional model corresponding to the interest point.

11. The information processing method according to claim 1, wherein the step of acquiring a two-dimensional view of the three-dimensional scene from the view point of the camera based on the three-dimensional scene and the distribution data of interest points within the shooting range comprises:
acquiring information of the interest point from the distribution data of interest points;
acquiring the annotation of the interest point based on the information of the interest point; and
generating a two-dimensional view of the three-dimensional scene from the view point of the camera and acquiring a position of the annotation of the interest point in the two-dimensional view, and adding the annotation of the interest point into the position in the two-dimensional view.

12. The information processing method according to claim 11, wherein the step of adding the annotation of the interest point into the position in the two-dimensional view comprises:
determining a presentation style of the annotation of the interest point based on the positional relationship between the camera and the interest point; and
adding the annotation of the interest point having the presentation style into the position of the annotation of the interest point in the two-dimensional view.

13. The information processing method according to claim 11, wherein:
the three-dimensional scene includes a sunshine simulation source; and
the step of adding the annotation of the interest point into the position in the two-dimensional view comprises:
determining a lighting presentation style of the annotation of the interest point based on a presentation position of the annotation of the interest point as well as a position of the sunshine simulation source; and
adding the annotation of the interest point having the lighting presentation style into the position of the annotation of the interest point in the two-dimensional view.

14. An information processing device, comprising:
an acquisition module for acquiring the current spatial position of a camera and its shooting range;
a three-dimensional modeling module for constructing a three-dimensional scene of the shooting range and setting the display property of the three-dimensional scene as transparent;
an integration module for acquiring a two-dimensional view of the three-dimensional scene from the view point of the camera based on the three-dimensional scene and the distribution data of interest points within the shooting range, wherein the two-dimensional view includes the annotation of an interest point whose position in the two-dimensional view corresponds to the position of the interest point in the current frame captured by the camera;
an adjustment module for adjusting the size of the two-dimensional view to match it with the size of the frame captured by the camera; and
a superposition output module for outputting the frame superposed with the two-dimensional view.

15. The information processing device according to claim 14, wherein:
the acquisition module is further configured for comparing the currently captured frame and the stored indoor image after determining the camera to be indoor, so as to determine the indoor position of the camera, or
the acquisition module is further configured for determining, after determining the camera to be indoor, the position of the camera when the current frame is being captured based on differences between the current frame captured indoor by the camera and the previous frame, and the indoor position of the camera when the previous frame was being captured.

16. The information processing device according to claim 15, further comprising an indoor determination module for determining the camera to be indoor based on a change in satellite positioning information.

17. The information processing device according to claim 14, further comprising:
an access receiving module for receiving an access to the annotation in the frame superposed with the two-dimensional view; and
an access response module for searching in pre-stored information for the detailed information of the interest point corresponding to the annotation, and outputting the detailed information of the interest point.

18. The information processing device according to claim 17, wherein:
the access response module is further configured for, for an interest point, replacing a text in the annotation of the interest point with the detailed information of the interest point, or replacing the annotation with an enlarged view or model.

19. The information processing device according to claim 14, further comprising a sheltered object processing module for, prior to the adjustment by the adjustment module, for a sheltered object from the view point of the camera in the three-dimensional model, setting the display property of the sheltered object as semi-transparent in the two-dimensional view.

20. The information processing device according to claim 14, further comprising a navigation routing module for, prior to the adjustment by the adjustment module, receiving destination information, and marking up a navigation route in the two-dimensional view based on the destination information.

21. The information processing device according to claim 14, wherein the integration module is further configured for acquiring the information of the interest point from the distribution data of interest points, obtaining the annotation of the interest point based on the information of the interest point, adding the annotation of the interest point into the position in the three-dimensional model corresponding to the interest point, and generating the two-dimensional view of the three-dimensional model from the view point of the camera.

22. The information processing device according to claim 21, wherein the integration module is further configured for determining the presentation style of the annotation of the interest point based on the positional relationship between the camera and the interest point, and adding the annotation of the interest point having the presentation style into the position in the three-dimensional model corresponding to the interest point.

23. The information processing device according to claim 21, wherein the three-dimensional modeling module is further configured for setting up a sunshine simulation source in the three-dimensional scene, and that the integration module is further configured for determining the lighting presentation style of the annotation of the interest point based on the presentation position of the annotation of the interest point as well as the position of the sunshine simulation source, adding the annotation of the interest point having the lighting presentation style into the position in the three-dimensional model corresponding to the interest point.

24. The information processing device according to claim 14, wherein the integration module is further configured for acquiring the information of the interest point from the distribution data of interest points, obtaining the annotation of the interest point based on the information of the interest point, generating the two-dimensional view of the three-dimensional model from the view point of the camera, obtaining the position of the annotation of the interest point in the two-dimensional view, and adding the annotation of the interest point into the position in the two-dimensional view.

25. The information processing device according to claim 24, wherein the integration module is further configured for determining the presentation style of the annotation of the interest point based on the positional relationship between the camera and the interest point, adding the annotation of the interest point having the presentation style into the position of the annotation of the interest point in the two-dimensional view.

26. The information processing device according to claim 24, wherein the three-dimensional modeling module is further configured for setting up a sunshine simulation source in the three-dimensional view, and the integration module is further configured for determining the lighting presentation style of the annotation of the interest point based on the presentation position of the annotation of the interest point as well as the position of the sunshine simulation source, and adding the annotation of the interest point having the lighting presentation style into the position of the annotation of the interest point in the two-dimensional view.

27. A computer program product for use in combination with a computer system, comprising a computer readable storage medium and a computer program embedded therein, the computer program comprising:
instructions for acquiring the current spatial position of a camera and its shooting range;
instructions for constructing a three-dimensional scene of the shooting range, and setting the display property of the three-dimensional scene as transparent;
instructions for obtaining a two-dimensional view of the three-dimensional view from the view point of the camera based on the three-dimensional view and the distribution data of interest points within the shooting range, wherein the two-dimensional view includes the annotation of the interest point whose position in the two-dimensional view corresponds to the position of the interest point of the current frame captured by the camera;
instructions for adjusting the size of the two-dimensional view to match it with the size of the frame captured by the camera; and
instructions for outputting the frame superposed with the two-dimensional view.
